(19) United States
(12) Patent Application Publication
(10) Pub. No.: US 2026/0208207 A1
(43) Pub. Date: Jul. 23, 2026

(54) DEVICES AND METHODS TO REDUCE AIR POLLUTION AND GLOBAL WARMING

(71) Applicant: Temple University of the Commonwealth System of Higher Education, Philadelphia, PA (US)

(72) Inventors: Rongjia Tao, Cherry Hill, NJ (US); Xiaojun Xu, Dresher, PA (US); Zhi Chen, Hillsborough, NJ (US)

(73) Assignee: Temple University of the Commonwealth System of Higher Education, Philadelphia, PA (US)

(21) Appl. No.: 19/141,111

(22) PCT Filed: Dec. 21, 2023
(86) PCT No.: PCT/US2023/085389

§ 371 Date: Jun. 19, 2025

Related U.S. Application Data
(60) Provisional application No. 63/434,666, filed on Dec. 22, 2022.

(51) Int. Cl. B03C 3/08; B01D 53/32; B03C 3/47; B03C 3/70

(52) U.S. Cl. CPC B03C 3/08; B01D 53/323; B03C 3/47; B03C 3/70; B01D 2257/204; B01D 2257/30; B01D 2257/406; B01D 2258/06; B03C 2201/24

(57) ABSTRACT

A device for capturing pollution particles from a fluid is disclosed. The device includes a chamber defining a fluid pathway through which the fluid travels from an inlet, through an interior, and toward. A filter is positioned within the interior of the chamber. The filter includes one or more pairs of flat metal electrodes positioned opposite one another, and the opposed pair of electrodes form at least one channel in the fluid pathway such that a non-laminar flow of fluid having pollution particles which move adjacent to the electrodes flows from a first end of the at least one channel to a second end of the at least one channel. A power source is coupled to the filter and produces an electric field oriented perpendicular to a direction of the non-laminar flow of fluid. The electric field has a strength sufficient to polarize pollution particles in the fluid.

### CROSS-REFERENCE TO RELATED APPLICATIONS

This application claims priority to U.S. Provisional Patent Application No. 63/434,666, filed on Dec. 22, 2022 and entitled DEVICES AND METHODS TO REDUCE AIR POLLUTION, the entire disclosure of which is incorporated by reference herein.

### FIELD OF THE INVENTION

The present invention relates generally to air filtration, and particularly, to devices and methods incorporating the application of an electric field to remove pollution particles from air, especially capture black carbon pollution to reduce global warming.

### BACKGROUND OF THE INVENTION

According to the assessment report, published by United Nations Environment Program (UNEP) and World Meteorological Organization (WMO) in 2011, the issue of black carbon for global warming is urgent, even more urgent than the long-term issue of CO2. Black carbon is the second largest contributor to global warming and climate change after carbon dioxide (CO2). Complete combustion would turn all carbon in the fuel into CO2. Black carbon is mainly formed by incomplete combustion of fossil fuels, including coal, wood and other fuels. In operation, combustion in large factories is conventionally incomplete, such that carbon monoxide, volatile organic compounds, organic carbon, and black carbon particles are all formed in the process. The complex mixture of particulate matter resulting from incomplete combustion is often referred to as soot. When suspended in the atmosphere, black carbon is very effective in absorbing light and heating its surroundings, thereby contributing to global warming by converting incoming solar radiation into heat. It also influences cloud formation and impacts regional circulation and rainfall patterns. The amount of energy stored in the atmosphere is measured as watts per square meter of Earth's surface. Black carbon stores 1.1 watts per square meter per year, just below CO2, which is responsible for 1.56 watts per square meter per year. Black carbon also accelerates iceberg melting. Unlike CO2, which can stay in the atmosphere indefinitely, black carbon particles remain in the atmosphere for a relatively shorter duration (e.g. days to weeks), before they return with rain or snow. When black carbon particles fall to earth with precipitation, they darken the surface of snow and ice, reducing their albedo (the reflecting power of a surface), warming the snow and ice, and hastening iceberg melting. According to a recent report published in Nature Communication, research at Himalayas-Tibet plateau has concluded that black carbon is mainly responsible for the glacier melting over there. Hence the current glacier melting all over the world is mainly caused by black carbon.

As emphasized by UNEP report, per unit of mass, black carbon has a warming impact on climate 460-1,500 times stronger than CO2. Therefore, if the amount of black carbon suspended in the atmosphere is increased slightly, the impact on global warming could be much worse. On the other hand, if we reduce the black carbon level in the air, we can reduce the global warming effect effectively. Therefore, reducing black carbon in the air is more urgent.

Additionally, according to the World Health Organization (WHO), outdoor air pollution kills an estimated seven million people worldwide every year. This mortality is due to exposure to fine particulate matter (PM) of 2.5 microns or less in diameter (PM2.5), which affects more people than any other pollutant. PM2.5 particles mainly originate from industrial processes, including burning, and is a common proxy indicator for air pollution. The major components of PM are black carbon, sulfate, nitrates, ammonia, sodium chloride, mineral dust and water. It consists of a complex mixture of solid and liquid particles of organic and inorganic substances suspended in the air. While particles with a diameter of 10 microns or less, (PM10) can penetrate and lodge deep inside the lungs, PM2.5 particles pose greater risk to health as they can penetrate the lung barrier and enter the blood system. Chronic exposure to these particles contributes to the risk of developing cardiovascular and respiratory diseases, as well as of lung cancer. Thus, PM2.5 carbon particles not only accelerate global warming and iceberg melting, but they are also among the leading environmental causes of poor health and premature death.

FIG. 1A depicts existing technology for fighting air pollution, electrostatic air filters, which are unable to catch black carbon pollution effectively. These existing filters can remove sulfate, nitrates, ammonia, and sodium chloride particles, but have difficulties in removing carbon particles. Indeed, for many conventional electrostatic air filters, an extra carbon filter is required to catch the carbon particles and other remaining polluters. However, such extra carbon filters have shorter lifetimes, cannot sustain higher temperatures, and cannot work with higher air flow. Consequently, current filter technologies are incompatible for use in large factories to prevent black carbon smokes from being emitted into the atmosphere.

In addition, FIG. 1B illustrates the mechanism of current electrostatic filters. In particular, when sufficient electrical potential is applied between a corona electrode and a collecting electrode, corona discharge takes place and ions are emitted. These ions travel toward the collecting electrodes and are attached to many dust particulates in the air if they are ionizable. Once these particles are ionized, they move toward the collecting electrodes under influence of the electric field. Eventually, they settle there and can be removed from the air. Examples of ionizable particles that may be filtered according to this process include sulfate, nitrates, ammonia, sodium chloride etc. However, carbon particles are more stable than these particles, and cannot be ionized by conventional electrostatic air filters. As a result, these filters fail to remove the carbon particles and require installation of an additional filter (e.g. carbon filter) to remove these non-ionizable polluter particles.

### SUMMARY OF THE INVENTION

Aspects of the present invention are related to devices and methods of applying an electric field to capture pollution particles from a fluid. In so doing, the devices and methods are suitable for reducing air pollution by capturing black carbon and other PM2.5 particles. As a result of the effective capture of black carbon and other PM2.5 particles, air filtration is more efficient, not only with respect to buildings and facilities in providing clean incoming air, but also appropriate for large factories in preventing further PM2.5 pollution from emitting into the atmosphere. Reduction of existing black carbon and other PM2.5 particles and prevention of further emission of black carbon and other PM2.5 particles into the atmosphere will improve the environment and reduce global warming.

In accordance with one aspect of the present invention, a device for capturing pollution particles from a fluid is disclosed. The device includes a chamber having an interior, an inlet through which the fluid flows into the interior, and an outlet through which the fluid flows from the interior. The inlet, the outlet, and the interior define a fluid pathway. A filter is positioned within the interior of the chamber. The filter has one or more pairs of flat metal electrodes positioned opposite one another, such that the opposed pair of electrodes forming at least one channel in the fluid pathway. In this way, a non-laminar flow of fluid having pollution particles which move adjacent to the electrodes flows from a first end of the at least one channel to a second end of the at least one channel. A power source is coupled to the filter and configured to produce an electric field oriented perpendicular to a direction of the non-laminar flow of fluid within the at least one channel. The electric field has an electric field strength sufficient to polarize pollution particles in the fluid.

In accordance with another aspect of the present invention, a filter for capturing pollution particles from a fluid is disclosed. The filter includes one or more pairs of flat metal electrodes positioned opposite one another. The opposed pair of electrodes form at least one channel in the fluid pathway such that a non-laminar flow of fluid flows from a first end of the at least one channel to a second end of the at least one channel. The filter has at least one insulate block disposed at the first end, second end, or combination thereof for facilitating the non-laminar flow of fluid having pollution particles which move adjacent to the electrodes through the filter. An electric field is applied perpendicular to a direction of the non-laminar flow of fluid within the at least one channel. The electric field has an electric field strength sufficient to polarize pollution particles in the fluid, thereby capturing polarizable and ionizable pollution particles from unfiltered fluid entering the filter via the first end.

In accordance with yet another aspect of the present invention, a method for capturing pollution particles from a fluid is disclosed. The method includes the steps of providing a chamber defining a fluid pathway. The chamber has an interior, an inlet through which the fluid flows into the interior, and an outlet through which the fluid flows from the interior. The inlet, the outlet, and the interior together define the fluid pathway. A filter is positioned within the interior of the chamber. The filter has one or more pairs of flat metal electrodes positioned opposite one another, and the opposed pair of electrodes form at least one channel in the fluid pathway such that a non-laminar flow of fluid having pollution particles which move adjacent to the electrodes flows from a first end of the at least one channel to a second end of the at least one channel. An electric field is applied perpendicular to a direction of the non-laminar flow of fluid within the at least one channel. The electric field has an electric field strength sufficient to polarize pollution particles in the fluid. This application of the electric field is ceased to remove captured polarizable and/or ionizable pollution particles from the filter.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features may be arbitrarily expanded or reduced for clarity. Included in the drawings are the following figures:

FIGS. 1A and 1B depict conventional electrostatic filters;

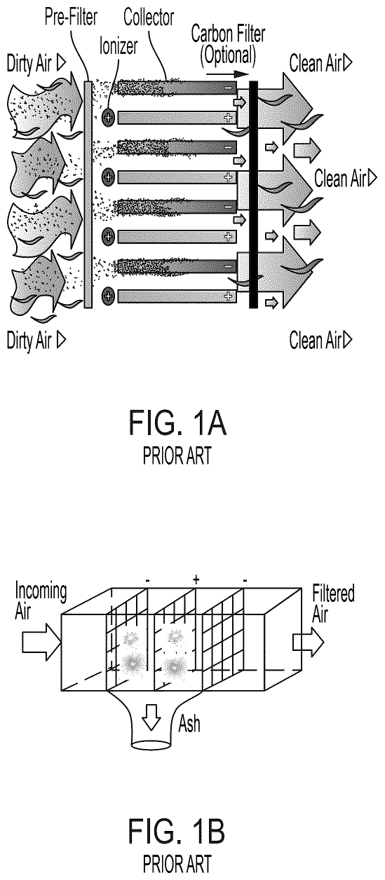

FIGS. 2A and 2B are illustrations depicting behavior of polarizable particles when placed adjacent electrodes and subjected to an electric field;

FIGS. 3A-3C depicts an exemplary device for capturing pollution particles from a fluid in accordance with aspects of the present invention;

FIGS. 4A-4B depicts an example laboratory set up for the device of FIG. 3A

FIG. 5 depicts a graph plotting particle concentration distribution relative to particle diameters;

FIGS. 6A-6B depict glass slides viewed under a microscope, showing air samples of incoming air flow collected before application of the electric field and outgoing or treated air flow collected after application of the electric field; and

FIG. 7 depicts a method for capturing pollution particles in a fluid in accordance with aspects of the present invention.

### DETAILED DESCRIPTION OF EXEMPLARY EMBODIMENTS OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

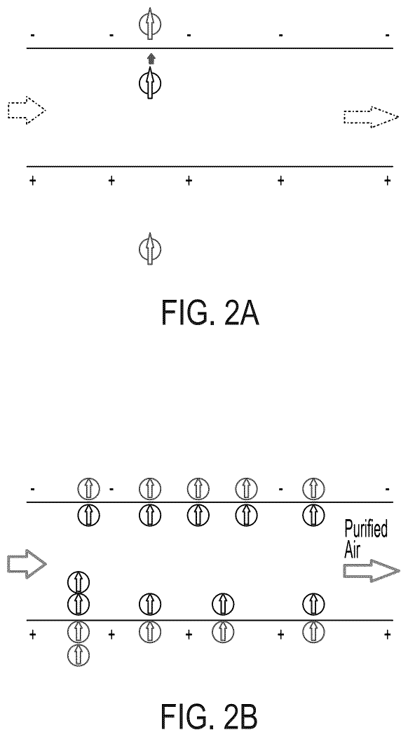

In accordance with aspects of the present invention, polluter or pollution particles, such as black carbon and other PM2.5 particles, are captured based on the technology of electrorheology. All polluter particles are polarized under a sufficiently strong electric field. If the electric field is further enhanced, some polluter particles, such as sulfate, nitrates, ammonia, sodium chloride, mineral dust, will be ionized, except carbon particles. Although PM2.5 carbon particles cannot be ionized, but they will be polarized in a strong electric field, such that the particles form electric dipoles having dipolar images induced through the electrodes (FIGS. 2A-2B). As illustrated in FIGS. 2A-2B, when a polarized carbon particle is adjacent an electrode, its nearest dipolar image strongly attracts it to the electrode. If the dipolar interaction is sufficiently strong, the PM2.5 carbon particles will be attracted to the nearest electrode and captured thereon (as shown in FIG. 2B).

It has been determined that the typical dielectric constant for carbon powder is εₚ=5.8~7.0, while other polluter particles have much higher dielectric constant. If the carbon particles are spheres with radius a, inside the static electric field, they are polarized with dipole moment:

$$\vec{p} = α {ε}_{f} {a}^{3} {\vec{E}}_{loc} \qquad ( 1 )$$

where α=(εₚ−ε_{f})/(εₚ+2ε_{f}), ε_{f} is the dielectric constant of air, and \vec{E}_{loc} is the local electrical field, which is stronger than the applied electric field. If the particle is located at distance d to its nearest electrode, the attractive force between the particle and its nearest image is given by:

$$F = \frac{3 {p}^{2}}{8 {d}^{4} {ε}_{f}} = \frac{3 {α}^{2} {a}^{6} {ε}_{f}}{8 {d}^{4}} {E}_{loc}^{2} \qquad ( 2 )$$

In order to examine this effect, this attractive force can be compared with the weight of the particle,

$$mg = \frac{4 π}{3} {a}^{3} ρ g , where ρ = 2.25 g / {cm}^{3} ,$$

the density of carbon;

$$F / mg = \frac{9 {α}^{2} {ε}_{f}}{32 π ρ ga {( d / a )}^{4}} {E}_{loc}^{2} \qquad ( 3 )$$

To estimate Equation (3), it can be assumed that carbon particle has α=1 μm, and the applied electric field is 10 kilovolt/cm (kV/cm). While the local field should be stronger than the applied electric field, for simplicity, it is approximated that E_{loc}=10 kV/cm. When the distance between the electrode and particle is about 3 times its radius, the resulting attractive force is approximately 3 times that of gravity on the particle. Moreover, as the particle moves closer to the electrode, the attractive force increases in strength. When the particle touches the electrode, the attractive force is approximately 240 times that of gravity. As such, once the carbon particles touch the electrodes, they will be captured thereon.

Although devices and methods according to aspects of the invention are discussed with respect to PM2.5 carbon particles, it will be understood that the devices and methods discussed throughout the specification are applicable to capture other polluter particles, including but not limited to other polarizable particles and ionizable particles. In fact, other PM2.5 polluter particles, including but not limited to sulfate, nitrates, ammonia, sodium chloride, mineral dust, etc., are more easily captured by the exemplary devices and methods than PM2.5 carbon particles, because these non-PM2.5 carbon particles are relatively easier to be polarized and even ionized.

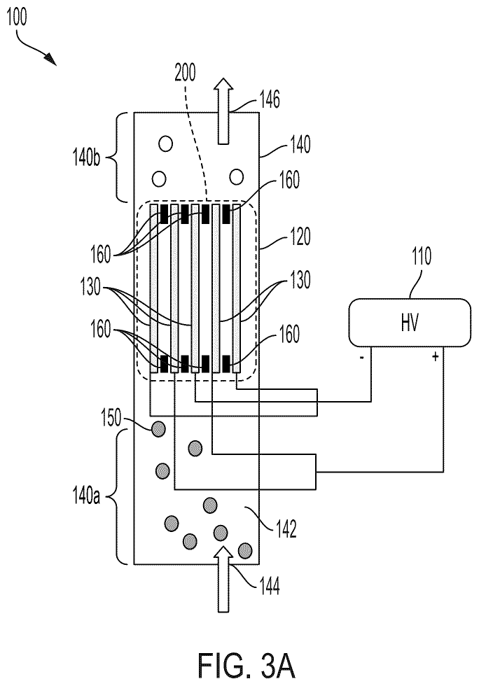

Referring now to the drawings, FIGS. 3A-3C illustrates a device 100 for capturing pollution particles from a fluid (e.g. air) in accordance with aspects of the present invention. Device 100 may be usable to filter a fluid to remove or reduce polluter or pollution particles 150 from the fluid, such as black carbon particles and other PM2.5 particles. As a general overview, device 100 includes a power source 110 and a filter 120 comprising one or more pairs of flat metal electrodes 130 to which the power source 110 is coupled. Additional details of device 100 are described below.

As shown in FIG. 3A, device 100 comprises a chamber 140 having an interior 142. The chamber 140 defines an inlet 144 through which the fluid having polluter particles 150 flows into the interior 142. The chamber 140 also defines an outlet 146 through which the fluid flows from and exits the interior 142. In this configuration, the inlet 144, the outlet 146, and the interior 142 defines a pathway through which the fluid travels. In an exemplary embodiment, the chamber 140 has a length extending from the inlet 144 to the outlet 146. Although FIG. 3A depicts chamber 140 as having a generally rectangular geometry, one skilled in the art would understand from the description herein that the size and shape of chamber 140 or generally, of device 100, is not limited to what is illustrated. For example, the size and shape of device 100, and its components thereof, may depend on the location of device 100 relative to the building, facility, or factory in which device 100 installed, e.g. in a HVAC (heating, ventilation and air conditioning) system of a building or facility, and/or may depend on the volume or rate of the flow to be filtered.

Positioned within the interior 142 of the chamber 140 is a filter 120. In an exemplary embodiment, the filter 120 extends along a partial length of the interior 142. Filter 120 comprises one or more pairs of metal electrodes 130 positioned opposite one another. In an exemplary embodiment, metal electrodes 130 are flat to facilitate easier removal of polluter particles collected by metal electrodes 130 when the electric field is deactivated or turned OFF. The opposed pair of electrodes 130 form at least one channel 132 in the fluid pathway, such that a flow of fluid having polluter particles 150 flows from a first end 132a of the at least one channel to an opposite second end 132b of the at least one channel.

In an exemplary embodiment, the flow of fluid is non-laminar. For example, the flow is a non-laminar flow of fluid with moving polluter particles 150 that are allowed to vary in distance from electrodes 130, such as to be close or adjacent to the electrodes 130 as the polluter particles 150 flow through channel 132. It has been determined that in a laminar flow of fluid, the Segre effect causes the suspended particles 150 in the flow to move toward the flow central axis 152 (as shown in FIG. 3B). This is because in a laminar flow, the shear stress is zero at the flow central axis 152 and highest at the flow edge or boundary (such as that defined by the electrodes 130). Therefore, due to the shear-thinning effect, the suspended particles 150 will move to the center axis of flow 152. When a particle 150 moves near the central flow axis 152, it will be less possible to facilitate attraction between the particle 150 and the electrodes 130 because the attractive forces from its two images cancel each other.

Therefore, a non-laminar flow, such as a non-laminar flow shown in FIG. 3C, is desired, so that the suspended particles move away from the flow central axis 152 and toward or adjacent the electrodes 130. With such non-laminar flow of fluid within channel 132, polluter particles 150, including but not limited to PM2.5 particles, are captured effectively.

In an exemplary embodiment, and as shown in FIG. 3A, the filter 120 is oriented parallel to the fluid pathway defined by the inlet 144, the outlet 146, and the interior 142 of chamber 140. The filter 120 is not limited to the illustrated location within chamber 140 shown in FIG. 3A. Rather, filter 120 may be disposed within chamber 140 in order to divide the interior 142 of the chamber 140 into an upstream section 140a in which the fluid flows from the inlet 144 and a downstream section 140b from which the fluid flows to the outlet 146 and exits chamber 140. In a non-limiting example, a total particle concentration of treated or filtered fluid at the downstream section 140b is reduced by at least 98% compared to a total particle concentration of unfiltered or untreated fluid at the upstream section 140a. In an exemplary embodiment, the pollution particles 150 comprise fine particulate matter having a polluter particle diameter in a range between 0.3 μm and 10.0 μm. In a non-limiting example, pollution particles 150 comprise polarizable particles, such as carbon particles. In another non-limiting example, pollution particles 150 comprise ionizable pollution particles. Ionizable pollution particles include sulfates, nitrates, ammonia, sodium chloride, or a combination thereof. In another non-limiting example, pollution particles 150 includes at least a combination of polarizable and ionizable particles.

A power source 110 is coupled to the filter 120 and configured to produce an electric field. The electric field has an electric field strength sufficient to polarize, but not ionize or not required to ionize, PM2.5 carbon particles pollution particles 150 in the fluid. Generally, carbon particles are not ionized but polarized in a sufficiently strong electric field. In one example, the electric field may have a strength sufficient to ionize the ionizable pollution particles. In another example, the electric field may not have a strength sufficient to ionize the ionizable pluttion particles. Nevertheless, both polarized pollution particles and ionized pollution particles are attracted to the electrodes 130 and captured thereon. In a non-limiting example, the electric field has a strength of no more than 11 kilovolt (kV)/cm, including e.g. 10 kV/cm, 9 kV/cm, 8 kV/cm, 7 kV/cm, 6 kV/cm, 5 kV/cm, etc., In another non-limiting example, the electric field may have a strength stronger (e.g. more than) 11 kV/cm, consistent with certain of the stated purposes of polarizing pollution particles and/or ionizing selected ionizable pollution particles. In an exemplary embodiment, and as shown by the arrows in FIG. 3C, the electric field is applied perpendicular to a direction of the non-laminar flow of fluid (as shown in FIG. 3C, for example) within the at least one channel 132. As a result of the flat metal electrodes 130 and the perpendicular orientation of the electric field relative to the direction of the non-laminar flow of fluid, the fluid flow rate through filter 120 remains sufficiently high and the captured polluter particles 150 can be efficiently removed. This configuration is suitable for large factory chimneys to prevent PM2.5 particles from being emitted into the atmosphere.

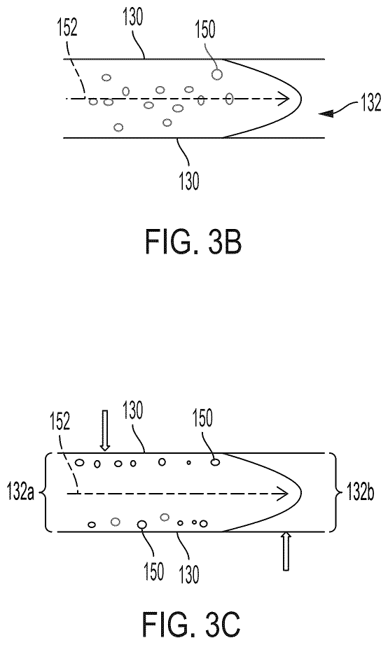

In an exemplary embodiment, device 100 further includes at least one component for promoting non-laminar flow (as shown in FIG. 3C, for example). In one example, the device may take the form of an insulate block 160 (FIGS. 3A and 4B) disposed at the first end 132a, second end 132b, or combination thereof 132a/132b for facilitating the non-laminar flow of fluid (as shown in FIG. 3C, for example) through the filter 120. Block 160 promotes non-laminar flow (as shown in FIG. 3C, for example), e.g., by creating turbulence in the flow entering and exiting channel 132, facilitating, guiding, and/or forcing the moving pollution particles 150 adjacent to the electrodes 130. Beyond the use of separate components for facilitating non-laminar flow, the shape, size, and/or orientation of the inlet end 132 of channel 132 may be designed to promote non-laminar flow (as shown in FIG. 3C, for example) through channel 132.

Still further, an airborne particle counter 170 is positioned at the outlet 146 for monitoring characteristics of filtered fluid exiting the chamber 140 via the outlet 146. These characteristics include, but are not limited to, quantitative and/or qualitative measurements of particle concentration of treated or filtered fluid.

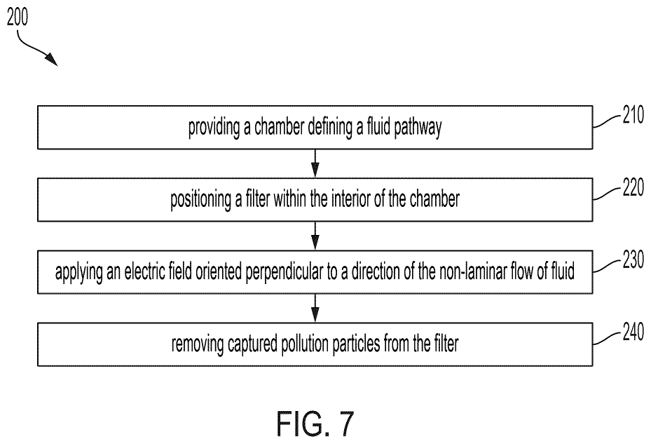

FIG. 7 illustrates a method 200 for capturing pollution particles in a fluid in accordance with aspects of the present invention. As a general overview, method 200 includes applying an electric field. Additional details of method 200 are described below with reference to device 100.

In step 210, a chamber defining a fluid pathway is provided. In an exemplary embodiment, chamber 140 has an interior 142. The chamber 140 also includes an inlet 144 through which the fluid flows into the interior 142 and an outlet 146 through which the fluid flows from the interior 142 and exits the chamber 140. Together, the inlet 144, the outlet 146, and the interior 142 define the fluid pathway through which the fluid having polluter particles 150 travels. In a non-limiting example, the pollution particles 150 comprise fine particulate matter having a polluter particle diameter in a range between 0.3 μm and 10.0 μm. The pollution particles 150 may comprise polarizable carbon particles.

In step 220, a filter is positioned within the interior of the chamber. In an exemplary embodiment, the filter 120 includes one or more pairs of flat metal electrodes 130 positioned opposite one another. The opposed pair of electrodes 130 form at least one channel 132 in the fluid pathway, such that a non-laminar flow (as shown in FIG. 3C, for example) of fluid, where the moving pollution particles 150 adjacent to the electrodes 130 flows from a first end 132a of the at least one channel 132 to a second end 132b of the at least one channel 132. In addition, the filter 120 is oriented parallel to the fluid pathway. The filter 120 is positionable within chamber 140 to divide the interior 142 of the chamber 140 into an upstream section 140a in which the fluid flows from the inlet 144 and a downstream section 140b from which the fluid flows to the outlet 146. Additionally or optionally, at least one insulate block 160 is positioned at the first end 132a, second end 132b, or combination thereof for facilitating the non-laminar flow of fluid (as shown in FIG. 3C, for example) through the filter 120, which has pollution particles 150 moving adjacent the electrodes 130.

In step 230, an electric field is applied. In an exemplary embodiment, a power source 110 is coupled to the filter 120. Power source 110 is configured to produce an electric field oriented perpendicular to a direction of a non-laminar flow of fluid (as shown in FIG. 3C, for example) within the at least one channel 132. In an exemplary embodiment, the electric field has an electric field strength sufficient to polarize, but not ionize or not required to ionize, PM2.5 carbon particles pollution particles 150 in the fluid. Additionally or optionally, the electric field has an electric field strength that is not sufficient to ionize pollution particles as set forth above. In a non-limiting example, the electric field has a strength of no more than 11 kV/cm, consistent with certain of the desired purposes of polarizing pollution particles and/or ionizing selected ionizable pollution particles as set forth above. In another non-limiting example, the electric field has a strength of more than 11 kV/cm, consistent with certain of the desired purposes of polarizing pollution particles and/or ionizing selected ionizable pollution particles as set forth above. Additionally or optionally, application of the electric field to the non-laminar flow of fluid is maintained for a predetermined duration. In addition or alternatively, application of the electric field to the non-laminar flow of fluid (as shown in FIG. 3C, for example) is maintained until a total particle concentration of filtered fluid at the downstream section 140b is reduced by a predetermined amount compared to a total particle concentration of unfiltered fluid at the upstream section 140a.

In step 240, captured polarizable and/or ionizable pollution particles are collected from the filter. In an exemplary embodiment, application of the electric field is ceased, so that the captured polarizable and/or ionizable pollution particles 150 are removed from the filter 120. The particles 150 are then removed from filter 120 by vacuuming the captured polarizable and/or ionizable pollution particles 150 from the filter 120.

### Examples of the Invention

When an electric field is applied perpendicular to a direction of the non-laminar flow of fluid within the filter, polluter particles, such as black carbon and PM2.5 particles, are captured effectively. Particularly, the electric field has an electric field strength sufficient to polarize (and optionally, not ionize) pollution particles in the fluid, such that the pollution particles are attracted by their dipole images, then aggregated on and caught by the electrodes of the filter. These results are supported by the following example laboratory tests, the results of which are shown in Table 1.

FIG. 4A shows a laboratory set up for device 100. An air source 190, such as a smoke generator, is disposed downwardly from the device 100. Incense or coal is used to generate stable smoke, which travel upwards toward and through channels 132 defined between a plurality of electrodes 130. The incomplete burning produces carbon particles and other polluter particles in the air flow. Adjacent the outlet 146 of device 100 or an end portion of chamber 140, an airborne particle counter 170 is disposed to monitor the outgoing air-smoke flow components. A pollution baseline of the air-smoke flow is determined at first. Then, a high voltage power supply 110 is applied to produce a strong electric field. When a high voltage is applied to the electrodes 130, a strong electric field perpendicular to the non-laminar air flow is produced. As shown in FIG. 4B, at the entrance and/or exits of the electric field generated in the filter 120, insulate blocks 160 are positioned to force the air flow entering the electric field closely along the surfaces of the electrodes 130. Generally, the direction of the air flow through channels 132 is defined by pathway 172 (FIG. 4B). The insulate blocks are so positioned, such that as the polluter particles 150 enter the electric field, the strong attractive force from their dipolar images makes it almost impossible for the polluter particles 150 to leave or move away from the electrodes 130. Therefore, the polluter particles 150 move along the surfaces of the electrodes 130 and are eventually captured thereon (FIG. 4B). Then, the components of treated or outgoing air are monitored by the particle counter 170 at various electric fields applied.

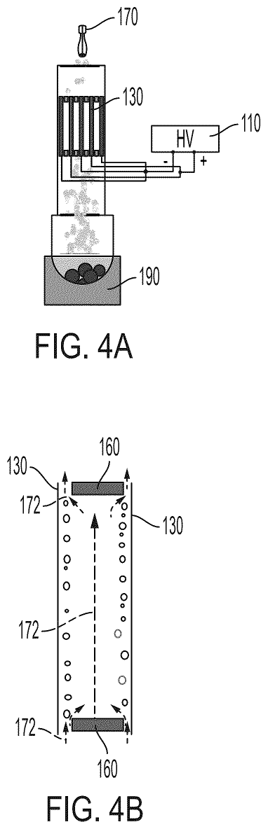

As shown in Table 1, improved reduction in air pollution is obtained when the applied electric field is 11 kV/cm. In this example, the incoming air flow has a high particle concentration at 248.60 μg/m3, with particle diameters being mainly between 0.3 μm and 10.0 μm. As shown in FIG. 5, which plots the concentration distribution relative to the particle diameters, the highest concentration is from particles with diameter around 3 μm. After an electric field of 11 kV/cm is applied, the total concentration is reduced to 4.00 μg/m3 from 248.60 μg/m3, indicating that the treated or outgoing air flow is improved or cleaner, as demonstrated by a total reduction of particle concentration by 98.39%. For particles having a diameter between 3-5 μm, the reduction is higher than 99%.

TABLE 1

| | Diameter | | | | | | | |
|---|---|---|---|---|---|---|---|---|
| | (μm) | 0.3 | 0.5 | 1.0 | 3.0 | 5.0 | 10.0 | Total |
| E = 0 V/cm | #/L | 72,843.35 | 87,441.78 | 56,278.91 | 3,424.69 | 699.07 | 0.86 | |
| | (average) | | | | | | | |
| E = 0 V/cm | Concentration | 1.96 | 10.87 | 55.99 | 91.99 | 86.93 | 0.86 | 248.60 |
| | (μg/m3) | | | | | | | |
| E = 11 kV/cm | #/L | 29,767.57 | 11,384.29 | 1,424.56 | 7.62 | 0.92 | 0.05 | |
| | (average) | | | | | | | |
| E = 11 kV/cm | Concentration | 0.80 | 1.42 | 1.42 | 0.20 | 0.11 | 0.05 | 4.00 |
| | (μg/m3) | | | | | | | |
| Reduction | | 59.13 | 86.98 | 97.47 | 99.78 | 99.87 | 94.45 | 98.39 |
| (%) | | | | | | | | |

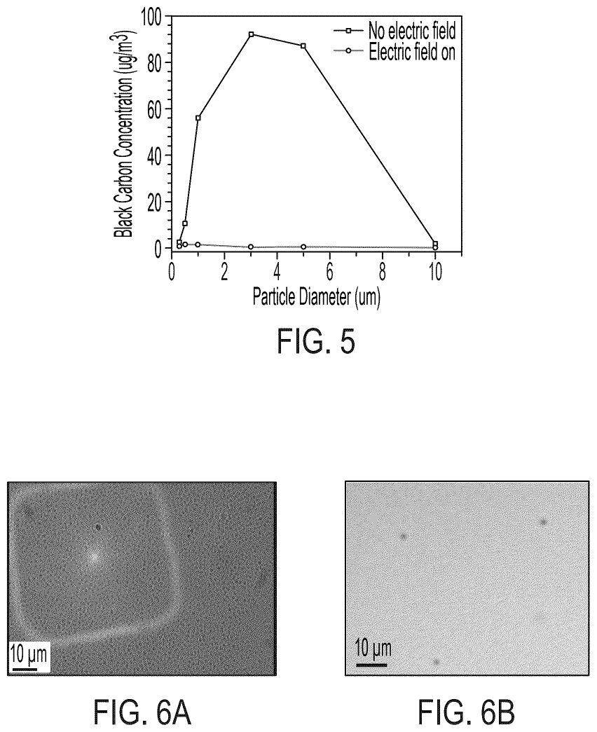

FIGS. 6A-6B illustrate glass slides viewed under a microscope, showing air samples of incoming air flow collected before application of the electric field (FIG. 6A) and outgoing or treated air flow collected after application of the electric field (FIG. 6B). Specifically, FIG. 6A depicts a sample taken with the glass slide inside the incoming air flow before the electric field is turned ON. As viewed under the microscope, the glass slide is full of polluter particles 150, mostly, black carbon particles. FIG. 6B depicts a sample taken with the glass slide inside the outgoing air flow after the electric field treatment. As viewed under the microscope, the glass slide is relatively clearer from a reduction in polluter particles, including carbon particles, which have been removed or reduced. Only a few large particles are visibly remaining, thereby confirming the results shown in Table 1, that more than 98% of polluter particles are removed and air pollution is reduced after application of the electric field.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

1. A device for capturing pollution particles from a fluid, the device comprising:
a chamber having an interior, an inlet through which the fluid flows into the interior, and an outlet through which the fluid flows from the interior, the inlet, the outlet, and the interior defining a fluid pathway;
a filter positioned within the interior of the chamber, the filter comprising one or more pairs of flat metal electrodes positioned opposite one another, the opposed pair of electrodes forming at least one channel in the fluid pathway such that a non-laminar flow of fluid having pollution particles which move adjacent to the electrodes flows from a first end of the at least one channel to a second end of the at least one channel; and
a power source coupled to the filter and configured to produce an electric field oriented perpendicular to a direction of the non-laminar flow of fluid within the at least one channel, the electric field having an electric field strength sufficient to polarize pollution particles in the fluid.

2. The device of claim 1, wherein the filter is oriented parallel to the fluid pathway and configured to divide the interior of the chamber into an upstream section in which the fluid flows from the inlet and a downstream section from which the fluid flows to the outlet.

3. The device of claim 2, wherein a total particle concentration of filtered fluid at the downstream section is reduced by at least 98% compared to a total particle concentration of unfiltered fluid at the upstream section.

4. The device of claim 1, wherein the pollution particles comprise fine particulate matter having a polluter particle diameter in a range between 0.3 μm and 10.0 μm.

5. The device of claim 4, wherein the pollution particles comprise polarizable carbon particles.

6. The device of claim 4, wherein the pollution particles comprise ionizable particles comprising sulfates, nitrates, ammonia, sodium chloride, or a combination thereof.

7. The device of claim 1, wherein the electric field has a strength of 11 kilovolt/cm.

8. The device of claim 1, further comprising at least one insulate block disposed at the first end, second end, or combination thereof for facilitating the non-laminar flow of fluid through the filter.

9. The device of claim 1, further comprising an airborne particle counter positioned at the outlet for monitoring characteristics of filtered fluid exiting the chamber via the outlet.

10. The device of claim 1, wherein the chamber has a length extending from the inlet to the outlet and the filter extends along a partial length of the interior.

11. A filter for capturing pollution particles from a fluid, the filter comprising:
one or more pairs of flat metal electrodes positioned opposite one another, the opposed pair of electrodes forming at least one channel in the fluid pathway, such that a non-laminar flow of fluid having pollution particles which move adjacent to the electrodes flows from a first end of the at least one channel to a second end of the at least one channel;
at least one insulate block disposed at the first end, second end, or combination thereof for facilitating the non-laminar flow of fluid through the filter; and
wherein an electric field is applied perpendicular to a direction of the non-laminar flow of fluid within the at least one channel, the electric field having an electric field strength sufficient to polarize pollution particles in the fluid, thereby capturing polarizable and ionizable pollution particles from unfiltered fluid entering the filter via the first end.

12. A method for capturing pollution particles from a fluid, the method comprising:
providing a chamber having an interior, an inlet through which the fluid flows into the interior, and an outlet through which the fluid flows from the interior, the inlet, the outlet, and the interior defining a fluid pathway;
positioning a filter within the interior of the chamber, the filter comprising one or more pairs of flat metal electrodes positioned opposite one another, the opposed pair of electrodes forming at least one channel in the fluid pathway such that a non-laminar flow of fluid having pollution particles which move adjacent to the electrodes flows from a first end of the at least one channel to a second end of the at least one channel;
applying an electric field oriented perpendicular to a direction of the non-laminar flow of fluid within the at least one channel, the electric field having an electric field strength sufficient to polarize pollution particles in the fluid; and
ceasing application of the electric field to remove captured polarizable and ionizable pollution particles from the filter.

13. The method of claim 12, wherein the ceasing application of the electric field comprises removing the filter from the chamber and vacuuming the captured polarizable and ionizable pollution particles from the filter.

14. The method of claim 12, wherein the pollution particles comprise fine particulate matter having a polluter particle diameter in a range between 0.3 μm and 10.0 μm.

15. The method of claim 14, wherein the pollution particles comprise polarizable carbon particles.

16. The method of claim 12, wherein the filter is oriented parallel to the fluid pathway and configured to divide the interior of the chamber into an upstream section in which the fluid flows from the inlet and a downstream section from which the fluid flows to the outlet.

17. The method of claim 16, further comprising maintaining the application of the electric field to the non-laminar flow of fluid for a predetermined duration and/or until a total particle concentration of filtered fluid at the downstream section is reduced by a predetermined amount compared to a total particle concentration of unfiltered fluid at the upstream section.

18. The method of claim 12, further comprising positioning at least one insulate block at the first end, second end, or combination thereof for facilitating the non-laminar flow of fluid through the filter.

19. The method of claim 12, wherein the electric field has a strength of 11 kilovolt/cm.

20. An air filter appliance comprising;
the device of claim 1;
an air source coupled to the upstream section of the chamber, wherein the air flows from the air source into the upstream section of the chamber.

21. The device of claim 1, wherein the electric field strength is not sufficient to ionize carbon pollution particles.

22. The method of claim 12, wherein the applied electric field strength is not sufficient to ionize carbon pollution particles.
